(19) United States
(12) Patent Application Publication
(10) Pub. No.: US 2017/0043518 A1
(43) Pub. Date: Feb. 16, 2017

(54) MOLDS AND METHODS OF MAKING MOLDS HAVING CONFORMING HEATING AND COOLING SYSTEMS

(71) Applicant: SABIC Global Technologies B.V., Bergen op Zoom (NL)

(72) Inventor: Venkatesha Narayanaswamy, Bangalore (IN)

(73) Assignee: SABIC Global Technologies, B.V., Bergen op Zoom (NL)

(21) Appl. No.: 15/306,111

(22) PCT Filed: Apr. 23, 2015
(86) PCT No.: PCT/IB2015/052976

§ 371 Date: Oct. 24, 2016

(30) Foreign Application Priority Data
Apr. 25, 2014 (IN) 1129/DEL/2014

(51) Int. Cl. B29C 45/73; B33Y 80/00; B29C 33/38; B22F 5/00; B29C 45/26; B33Y 10/00; B22F 3/105

(52) U.S. Cl. CPC B29C 45/7312; B33Y 10/00; B33Y 80/00; B22F 3/1055; B22F 5/007; B29C 45/26; B29C 33/3842; B22F 2301/35; B22F 2303/01; B22F 2998/10; B29K 2905/12

(57) ABSTRACT

A method for forming a mold apparatus comprising: forming a cavity portion through an additive manufacturing process; wherein the cavity portion comprises a cavity molding surface having a surface roughness of greater than or equal to about 0.025 μm and a plurality of cavity fluid channels; wherein the cavity fluid channels comprise a profile conforming to the profile of the cavity molding surface; treating the cavity molding surface to reduce the surface roughness to less than about 0.025 μm; forming a core portion through additive manufacturing; wherein the core portion comprises a core molding surface and a plurality of core fluid channels; wherein the core fluid channels conform to the core molding surface.

### BACKGROUND

This disclosure relates to a mold having heating and cooling systems that conform to the molding surfaces and methods of making the same. In particular, disclosed herein is a mold including portions formed through Additive Manufacturing (AM) and portions formed through other processes. The mold can be used to form thin-walled thermoplastic products with specific surface features.

The global plastics industry is constantly looking for innovative solutions to increase profitability and reduce internal production costs. Towards achieving this bigger objective, multiple tiers in the value chain such as product designers, equipment suppliers, raw material suppliers, tooling suppliers and polymer processers are innovating newer technologies. One such development specific to injection molding is heat and cool technology.

With heat and cool technology, the injection mold surface is rapidly heated during the injection phase by pressurized hot water and also rapidly cooled during the cool phase by passing pressurized cold water, with-in every injection molding cycle. A typical heat and cool molding cycle includes first heating the mold above Glass Transition Temperature (Tg) before the injection of plastic melt into cavity and then the mold is cooled to below Ejection Temperature (Te) before part ejection. This alternate heating and cooling of the mold surface repeats during every molding cycle. Thus, the production process is limited by the duration molding cycle.

However, geometrical considerations of the mold apparatus as well as flow parameters have the significant influence on the heat up and cool down time. For example, a mold apparatus formed through machining a block of material includes straight cooling/heating channels, which are not sufficient for the optimum manufacturing of parts with complex geometries (e.g., non-linear parts, three-dimensional shaped parts). This is due to the varying distance between the mold surface and the cooling/heating channels, which contributes to a non-uniform temperature distribution and longer molding cycles. Also, in conventional machining processes the straight cooling lines can be 10 to 15 millimeters (mm) away from the molding surface. As a result, the heat up and cool down time can increase, which can increase the molding cycle time and reduce productivity.

Additive Manufacturing (AM) is a new production technology that is transforming the way all sorts of things are made. AM makes three-dimensional (3D) solid objects of virtually any shape from a digital model. Generally, this is achieved by creating a digital blueprint of a desired solid object with computer-aided design (CAD) modeling software and then slicing that virtual blueprint into very small digital cross-sections. These cross-sections are formed or deposited in a sequential layering process in an AM machine to create the 3D object. AM has many advantages, including dramatically reducing the time from design to prototyping to commercial product. Running design changes are possible. Multiple parts can be built in a single assembly. No tooling is required. Minimal energy is needed to make these 3D solid objects. It also decreases the amount waste and raw materials. AM also facilitates production of extremely complex geometrical parts. AM also reduces the parts inventory for a business since parts can be quickly made on-demand and on-site.

Powder Bed Fusion (a type of AM) can be used as a low capital forming process for producing both metal and plastic parts, and/or forming processes for difficult geometries. Powder Bed Fusion involves a powder bed-based additive manufacturing system that is used to build a three-dimensional (3D) model from a digital representation of the 3D model in a layer-by-layer manner by using thermal energy to selectively fuse regions in a powder bed. Laser sintering is one commonly known powder bed fusion process. The powder bed material (made of either very small plastic or metal particles) is selectively exposed to a laser beam or other focused thermal energy source to fuse portions of the powder bed particles together in a pattern in an x-y plane. After the exposed particles have been fused together, a new fresh powder bed is placed over the fused layer. The new powder bed is then exposed to a laser beam or other thermal energy source in a x-y plane to form a new pattern. This new pattern of fused particles also fuses with portions of the fused pattern below it to form a bonded pattern along the z-axis (perpendicular to the x-y plane), and the process is then repeated to form a 3D model resembling the digital representation.

Material Extrusion (another type of AM) can be used as a low capital forming process for producing plastic parts, and/or forming process for difficult geometries. Material Extrusion involves an extrusion-based additive manufacturing system that is used to build a three-dimensional (3D) model from a digital representation of the 3D model in a layer-by-layer manner by extruding a flowable modeling material. The modeling material is extruded through an extrusion tip carried by an extrusion head, and is deposited as a sequence of roads on a substrate in an x-y plane. The extruded modeling material fuses to previously deposited modeling material, and solidifies upon a drop in temperature. The position of the extrusion head relative to the substrate is then incremented along a z-axis (perpendicular to the x-y plane), and the process is then repeated to form a 3D model resembling the digital representation.

However, a molding apparatus formed through an Additive Manufacturing process (AM) can have molding surfaces that are rough. As such, the molded article formed using the molding apparatus can require a post-molding finishing process, which further adds to production time and cost.

Accordingly, a need exists for molds and methods of producing molds that are capable of rapid molding cycles and uniform temperature distribution while maintaining desired surface parameters.

### SUMMARY

Disclosed herein are molds having a conformal heating/cooling design that follows the profile of the molding surface resulting in a uniform temperature distribution of the molding surface, methods of making the same, and products formed by the same.

A method for forming a mold apparatus comprising: forming a cavity portion through an additive manufacturing process; wherein the cavity portion comprises a cavity molding surface having a surface roughness of greater than or equal to about 0.025 μm and a plurality of cavity fluid channels; wherein the cavity fluid channels comprise a profile conforming to the profile of the cavity molding surface; treating the cavity molding surface to reduce the surface roughness to less than about 0.025 μm; forming a core portion through additive manufacturing; wherein the core portion comprises a core molding surface and a plurality of core fluid channels; wherein the core fluid channels conform to the core molding surface.

A method of forming a mold apparatus comprising: forming a cavity insert comprising a cavity surface having roughness of less than or equal to about 0.025 μm; forming a cavity portion opposite the cavity surface through additive manufacturing; wherein the cavity portion comprises a plurality of cavity fluid channels; wherein the cavity fluid channels comprise a profile conforming to the profile of the cavity molding surface; forming a core portion through additive manufacturing; wherein the core portion comprises a core molding surface and a plurality of core fluid channels; wherein the core fluid channels conform to the core molding surface.

A mold apparatus comprising: a core portion comprising a core molding surface and a plurality of core fluid channels; wherein the core fluid channels conform to the profile of the core molding surface; a cavity portion comprising a cavity molding surface and a plurality of cavity fluid channels; wherein the cavity fluid channels conform to the profile of the cavity surface; wherein at least one of the core molding surface and the cavity molding surface comprise a roughness of less than about 0.025 μm.

A method for molding a polymer comprising: heating a core molding surface through passing a heated fluid through a plurality of core channels; wherein the plurality of core channels conform to the core molding surface; wherein the core molding surface comprises a roughness of less than or equal to about 0.025 μm; heating a cavity molding surface through passing a heated fluid through a plurality of cavity channels; wherein the plurality of cavity channels conform to the cavity molding surface; wherein the cavity molding surface comprises a roughness of less than or equal to about 0.025 μm; injecting a polymeric material between the core portion and the cavity portion; applying pressure to the polymeric material to form a polymeric product; cooling the core molding surface and the cavity molding surface through passing a cooling fluid through the plurality of core fluid channels and cavity channels; ejecting the polymeric product.

The above described and other features are exemplified by the following figures and detailed description.

### BRIEF DESCRIPTION OF THE DRAWINGS

Refer now to the figures, which are exemplary embodiments, and wherein the like elements are numbered alike.

FIG. 1 is a cross sectional top view of a molding apparatus formed through a non-additive manufacturing technique.

FIG. 2 is a cross sectional top view of molding apparatus formed through the processes disclosed herein.

FIG. 3 is a cross sectional top view of molding apparatus formed through the processes disclosed herein.

FIG. 4A and FIG. 4B are the plan views of a mold apparatus formed through the processes disclosed herein.

FIG. 5 is a flow diagram depicting a process for forming the mold of FIG. 2

FIG. 6 is a flow diagram depicting a process for forming the mold of FIG. 3

FIG. 7A and FIG. 7B are the Computer Aided Designs (CAD) of cavity and core mold portions for a cell phone cover.

FIG. 8A and FIG. 8B are the Computer Aided Designs (CAD) of fluid channels for use in the cavity and core mold portions of FIG. 7A and FIG. 8, respectively.

FIG. 9 is a representation of the front side a generic automotive lighting reflector part.

FIG. 10 is a representation of the back side the generic automotive lighting reflector part of FIG. 9.

FIG. 11 is a representation of an exploded view of the generic automotive lighting reflector part of FIGS. 9 and 10 in a cavity and core molding apparatus having conformal cooling lines in both the cavity and the core portions of the mold.

FIG. 12 is representation of a sectional view of the cavity portion of the mold shown in FIG. 11 having the upper and lower conformal cooling designs incorporated therein.

FIG. 13 is representation of a side view of the upper and lower conformal cooling designs for the cavity portion of the mold as shown in FIG. 11.

FIG. 14 is representation of a sectional view of the core portion of a mold shown in FIG. 11 having the conformal cooling design incorporated therein.

### DETAILED DESCRIPTION

Disclosed herein are molds and methods of producing molds including heating and cooling systems that conform to the molding surface. The molds disclosed herein are capable of rapid and uniform heating and cooling and form parts that meet stringent surface quality requirements. It is believed that the favorable results obtained herein, e.g., a molding apparatus capable of rapid mold cycles and uniform temperature distribution, can be achieved through producing cavity and core portions with conformal heating/cooling (fluid) channels and including cavity and/or core surfaces that meet a specific surface roughness requirement.

The mold portions can be formed through multiple processes. For example, portions of the mold can be formed through Additive Manufacturing and other portions of the mold can be formed through a machining process. The cavity portion can include an insert that includes the molding surface formed through a machining process, such as through the use of Computer Numerical Control (CNC) machine. The insert can have a thickness of about 1 to about 7 millimeters (mm). The insert can have a thickness of about 3 to about 5 mm. The cavity portion can include cooling/heating (fluid) channels that are conformal to the cavity molding surface and formed through an Additive Manufacturing process. The cavity portion can include a surface formed through Additive Manufacturing and treated to reduce the surface roughness. The treatment can include machining, polishing, chemical treatment, chrome plating, nickel plating, puffing and polishing by diamond paste, super finishing, lapping and combinations including at least one of the foregoing.

The core portion can include an insert that includes the molding surface formed through a machining process, such as through the use of Computer Numerical Control (CNC) machine. The insert can have a thickness of about 1 to about 7 millimeters (mm). The insert can have a thickness of about 3 to about 5 mm. The core portion can include cooling/heating (fluid) channels that are conformal to the core molding surface and formed through an Additive Manufacturing process. The core portion can include a core surface formed through Additive Manufacturing. The core surface can be treated to reduce the surface roughness. The treatment can include machining, polishing, chemical treatment, chrome plating, nickel plating, puffing and polishing by diamond paste, super finishing, lapping and combinations including at least one of the foregoing.

As used herein “conformal to the molding surface” means that the channels can be at a predetermined distance from the molding surface that can vary by less than 5% across the molding surface. For example, the channels can be set at a distance of about 3 to about 5 millimeters (mm) from the molding surface and this distance can remain the same across the molding surface. Thus, the channels can be non-linear or three-dimensional to conform to a curved or angled molding surface. The channels can be at a predetermined distance from the molding surface that can vary by less than 3% across the molding surface. The channels can be at a predetermined distance from the molding surface that can vary by less than 1% across the molding surface.

The mold surface of the cavity and core portion can include a surface texture with a low surface roughness. For example, the cavity surface can include a surface texture that have an average roughness (Ra) of less than or equal to 0.025 μm. The cavity surface can include a surface texture that have an average roughness (Ra) of about 0.012 to about 0.025 μm. Ra is measured using standard surface profiling instruments such as a Mitutoyo SJ210 Surface Roughness Tester. The procedures set forth in ASME B46.1 (2002) are followed to configure the instrument and measure Ra.

Powder Bed Fusion and Material Extrusion parts can be used to form portions of molds for making thermoplastic parts for a wide variety of useful products including smartphone cases and similar thin-walled components. The term “Powder Bed Fusion” involves building a part or article layer-by-layer by selectively heating regions of a powder bed to adjacent particles in the bed together according to computer-controlled paths. Powder Bed Fusion can utilize a modeling material with or without a support material. The modeling material includes the finished piece, and the support material includes scaffolding that can be mechanically removed when the process is complete. The process involves depositing material to complete each layer before the base moves down the Z-axis and the next layer begins. For example, the powder bed material can be made of either metal or plastic particles. Powder bed fusion includes laser sintering, laser fusing, laser metal deposition as well as other powder bed fusion technologies as defined by ASTM F2792-12a.

The term “Material Extrusion” involves building a part or article layer-by-layer by heating thermoplastic material to a semi-liquid state and extruding it according to computer-controlled paths. Material extrusion can utilizes a modeling material with or without a support material. The modeling material includes the finished piece, and the support material includes scaffolding that can be mechanically removed, washed away or dissolved when the process is complete. The process involves depositing material to complete each layer before the base moves down the Z-axis and the next layer begins. For example, the extruded material can be made by laying down a plastic filament or string of pellets that is unwound from a coil or is deposited from an extrusion head. These monofilament additive manufacturing techniques include fused deposition modeling and fused filament fabrication as well as other material extrusion technologies as defined by ASTM F2792-12a.

The molded material can be made from thermoplastic materials. Such materials can include polycarbonate (PC), acrylonitrile butadiene styrene (ABS), acrylic rubber, ethylene-vinyl acetate (EVA), ethylene vinyl alcohol (EVOH), liquid crystal polymer (LCP), methacrylate styrene butadiene (MBS), polyacetal (POM or acetal), polyacrylate and polymethacrylate (also known collectively as acrylics), polyacrylonitrile (PAN), polyamide (PA, also known as nylon), polyamide-imide (PAI), polyaryletherketone (PAEK), polybutadiene (PBD), polybutylene (PB), polyesters such as polybutylene terephthalate (PBT), polycaprolactone (PCL), polyethylene terephthalate (PET), polycyclohexylene dimethylene terephthalate (PCT), and polyhydroxyalkanoates (PHAs), polyketone (PK), polyolefins such as polyethylene (PE) and polypropylene (PP), fluorinated polyolefins such as polytetrafluoroethylene (PTFE) polyetheretherketone (PEEK), polyetherketoneketone (PEKK), polyetherimide (PEI), polyethersulfone (PES), polysulfone, polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polyphenylsulfone, polytrimethylene terephthalate (PTT), polyurethane (PU), styrene-acrylonitrile (SAN), or any combination comprising at least one of the foregoing. Polycarbonate blends with ABS, SAN, PBT, PET, PCT, PEI, PTFE, or combinations thereof are of particular note to attain the balance of the desirable properties such as melt flow, impact and chemical resistance. The amount of these other thermoplastic materials can be from 0.1% to 70 wt. %, in other instances, from 1.0% to 50 wt. %, and in yet other instances, from 5% to 30 wt %, based on the weight of the monofilament.

The polymeric material can include a filler or reinforcing material. As used herein, a reinforcing material can include a fibers, (continuous, chopped, woven, and the like) formed of aramid, carbon, basalt, glass, plastic, metal (e.g. steel, aluminum, magnesium), quartz, boron, cellulose, liquid crystal polymer, high tenacity polymer (e.g., polypropylene, polyethylene, poly(hexano-6-lactam), poly[imino(1,6-dioxohexamethylene) imnohexamethylene]), thermoplastic polymer fibers, thermoset polymer fibers, or natural fibers, as well as combinations comprising at least one of the foregoing. An exemplary fiber filled resin is STAMAX™ resin, which is a long glass fiber filled polypropylene resin also commercially available from SABIC Innovative Plastics. Another exemplary fibrous material can include long fiber reinforced thermoplastics (VERTON™ resins, commercially available from SABIC Innovative Plastics).

The polymeric material can include about 10 to 90 wt. % fibers and 90 to 10 wt. % polymeric material. The fibrous polymeric material can include about 25 to 75 wt. % fibers and 75 to 25 wt. % polymeric material. The fibers used for can include long fibers, e.g., fibers having an aspect ratio (length/diameter) of greater than or equal to about 10. The fibers can include an aspect ratio greater than or equal to about 50. The fibers can include an aspect ratio from about 50 to about 500. The fibers can include an aspect ratio of about 80 to about 400. For example, the diameter of the long fiber may range from 5 to 35 micrometers (μm). The diameter of the long fiber can be about 10 to about 20 μm. The fibers can have a length, for example, of greater than or equal to about 0.4 mm. The fibers can include a length of greater than or equal to about 1 mm. The fibers can include a length of greater than or equal to about 2 mm.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

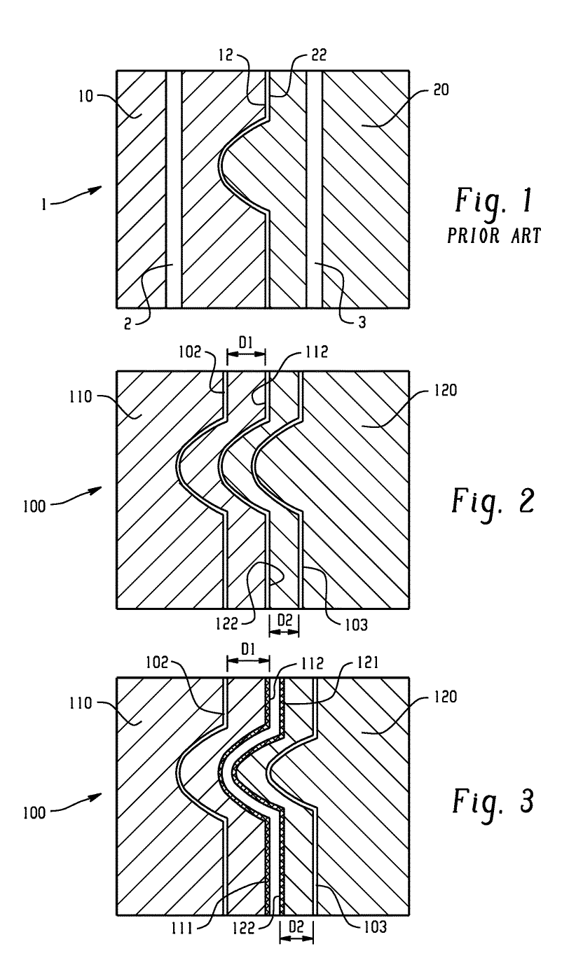

FIG. 1 illustrates a prior art mold apparatus 1 formed through a CNC machining process. As shown in FIG. 1, mold apparatus 1 includes cavity portion 10 and core portion 20. Cavity portion 10 includes fluid channels 2 for heating and cooling cavity mold surface 12. Core portion 20 includes fluid channels 3 for heating and cooling core mold surface 22. As illustrated in FIG. 1, Fluid channels 2 and 3 are straight and do not conform to the cavity mold surface 12 or core mold surface 22. The fluid channels cannot conform to a complex (e.g., curved, multiple angles, three-dimensional shapes etc.) mold surface due to the limitations of the CNC machining process. Thus, the distance between the molding surface and the fluid channels can vary significantly. Due to this variation, attaining a uniform mold surface temperature is difficult, time consuming, and inefficient.

FIG. 2 illustrates a mold apparatus 100 including a cavity portion 110 and a core portion 120. Cavity portion 100 can include cavity mold surface 112 and fluid channels 102. As shown in FIGS. 2 and 3, the fluid channels 102 conform to cavity mold surface 112. In other words, the distance between cavity mold surface 112 and fluid channels 102 represented by D1 can vary by less than 5% at any point across cavity surface 112. The distance between the cavity mold surface 112 and fluid channels 102 represented by D1 can vary by less than 3% at any point across cavity mold surface 112. The distance between the cavity mold surface 112 and fluid channels 102 represented by D1 can vary by less than 1% at any point across cavity mold surface 112.

Core portion 120 can include core mold surface 122 and fluid channels 103. As shown in FIGS. 2 and 3, fluid channels 103 can conform to core mold surface 122. In other words, the distance between core mold surface 122 and fluid channels 103 represented by D2 can vary by less than 5% at any point across core surface 122. The distance between the core mold surface 122 and fluid channels 103 represented by D2 can vary by less than 3% at any point across core mold surface 122. The distance between the core mold surface 122 and fluid channels 103 represented by D2 can vary by less than 1% at any point across core mold surface 122.

Cavity mold surface 112 and core mold surface 122 can provide a uniform temperature profile. For example, cavity mold surface 112 can have a surface temperature that varies by less than or equal to about 3% at any point on core mold surface 112. Cavity mold surface 112 can have a surface temperature that varies by less than or equal to about 1% at any point on cavity mold surface 112. In addition, core mold surface 122 can include a surface temperature that can vary by less than or equal to about 3% at any point on core mold surface 122. Core mold surface 122 can include a surface temperature that can vary by less than or equal to about 1% at any point on core mold surface 122.

FIG. 3 illustrates an alternative to FIG. 2, wherein cavity insert 111 includes cavity mold surface 112. In addition, core insert 121 can include core surface 122. Cavity insert 111 and core insert 121 can include the same material as cavity portion 110 and core portion 120. In the alternative, cavity insert 111 and/or core insert 121 can include different materials from cavity portion 110 and/or core portion 120.

Cavity mold surface 112 can include an average surface roughness of 0.012 to 0.025 μm. Core mold surface 122 can include an average surface roughness of 0.012 to 0.025 μm.

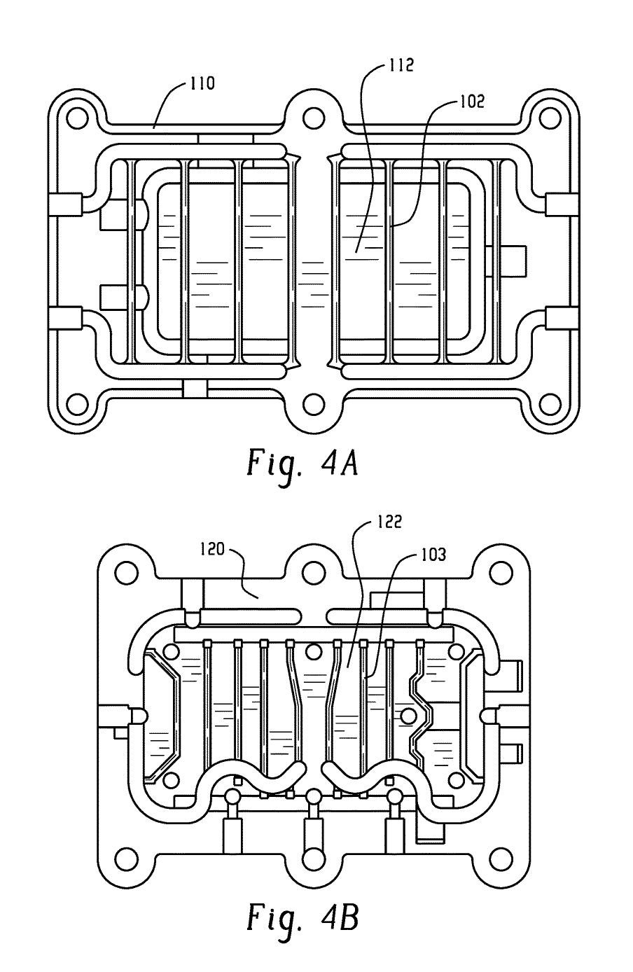

FIG. 4A and FIG. 4B illustrate plan views of cavity mold portion 110 and cavity mold portion 120 for molding a thermoplastic article, such as a cell phone cover. The article can include a thin walled structure. For example, the article can include walls that are less than or equal to about 1 mm in thickness. The article can include walls that are less than or equal to about 0.8 mm in thickness. As shown in FIG. 4A and FIG. 4B, the fluid channels 102, 103 conform to the profile (cross sectional shape) of the mold. In other words, a consistent distance is maintained between the cavity mold surface 112 and channels 102, and core mold surface 122 and fluid channels 103.

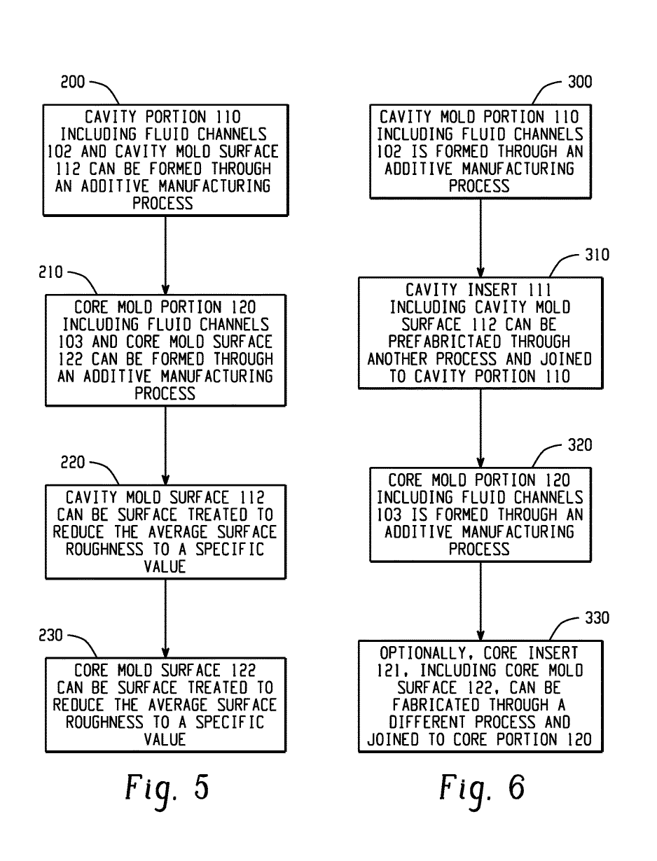

FIG. 5 illustrates a process for manufacturing the mold of FIG. 2. Cavity portion 110 including fluid channels 102 and cavity mold surface 112 can be formed through an Additive Manufacturing process in step 200. Core mold portion 120 including fluid channels 103 and core mold surface 122 can be formed through an Additive Manufacturing process in step 210. Cavity mold surface 112 can be surface treated to reduce the average surface roughness to a specific value in step 220. For example, cavity mold surface 112 can be treated by one or more of machining, laser polishing, chemical treatment, chrome plating, nickel plating, puffing and polishing by diamond paste, super finishing, lapping, and combinations including at least one of the foregoing. Optionally, in step 230, core mold surface 122 can be surface treated to reduce the average surface roughness to a specific value. For example, core mold surface 122 can be treated by one or more of machining, laser polishing, chemical treatment, Chrome plating, nickel plating, puffing and polishing by diamond paste, super finishing, lapping, and combinations including at least one of the foregoing.

FIG. 6 illustrates a process for manufacturing a mold apparatus. As illustrated in FIG. 6, cavity mold portion 110 including fluid channels 102 is formed through an Additive Manufacturing process in step 300. Cavity insert 111 including cavity mold surface 112 can be prefabricated through another process and joined to cavity portion 110 in step 310. Core mold portion 120 including fluid channels 103 is formed through an Additive Manufacturing process in step 320. Optionally, core mold portion 120 can include core mold surface 122. In the alternative, core insert 121 can be prefabricated through a different process and joined to core portion 120 in step 330.

### EXAMPLES

### Example 1

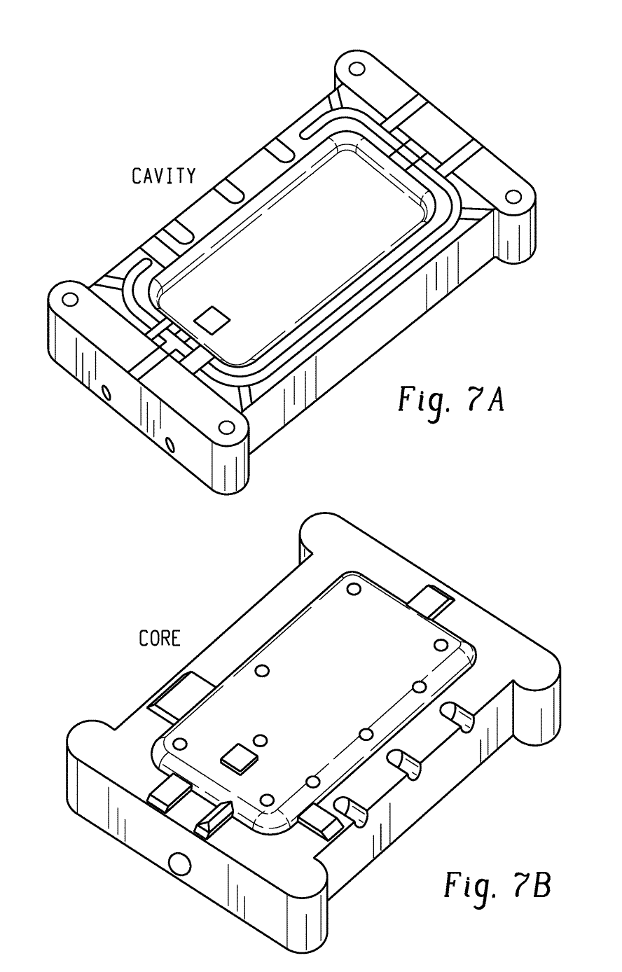

A computer simulation was run using a Computer Aided Design (CAD) model of the cavity and core for a typical mobile cover tool made from Lexan HF 1110R, as shown in FIG. 7A and FIG. 7B. The different components of the tool and their material properties including thermal conductivity data are tabulated in Table 1.

TABLE 1

| | | | | | | Thermal | | |
|---|---|---|---|---|---|---|---|---|
| Component | Material | Density | | Specific | | Conductivity | | Reference |
| Cavity | P20 | 7860 | kg/m\hat{ }3 | 130 | J/kg · K | 41.5 | W/m-K | Larobe LSS^{TW} |
| | | | | | | | | P20 Mold STEEL |
| | | | | | | | | (ASTM P20) |
| Core | P20 | 7860 | kg/m\hat{ }3 | 130 | J/kg · K | 41.5 | W/m-K | Larobe LSS^{TW} |
| | | | | | | | | P20 Mold STEEL |
| | | | | | | | | (ASTM P20) |
| Ejector | EN36 | 7860 | kg/m\hat{ }3 | 130 | J/kg · K | 63 | W/m-K | |
| pins | | | | | | | | |
| Support | HSCS 36 | 7860 | kg/m\hat{ }3 | 130 | J/kg · K | 63 | W/m-K | |
| pins | | | | | | | | |
| Mobile | Lexan | 1.1915 | g/cm\hat{ }3 | 2000 | J/g-C | 0.26 | W/m-K | Lexan |
| cover | HF1110R | | | | | | | HF1110R |

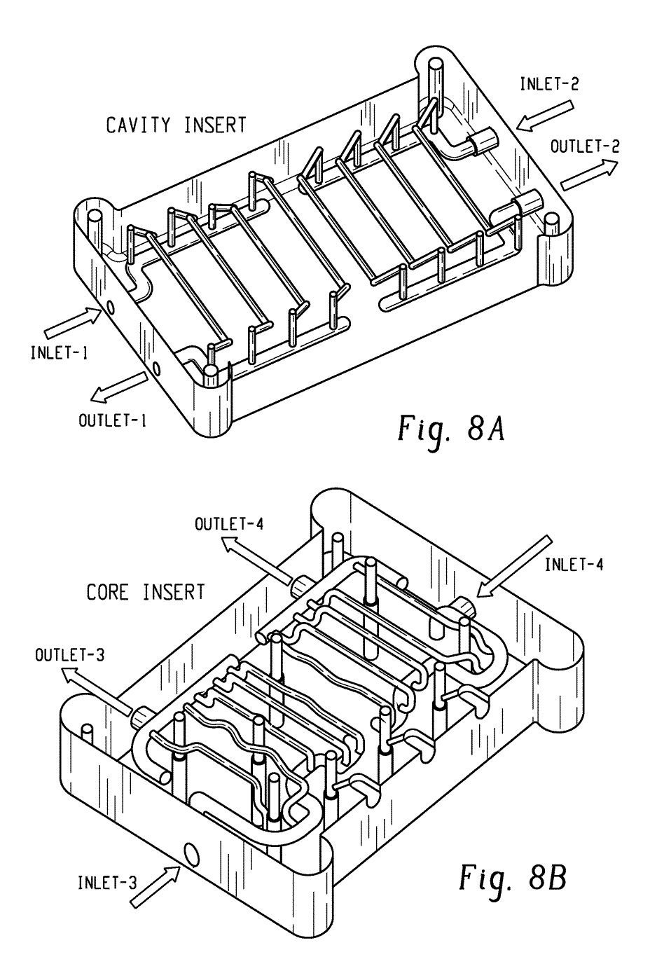

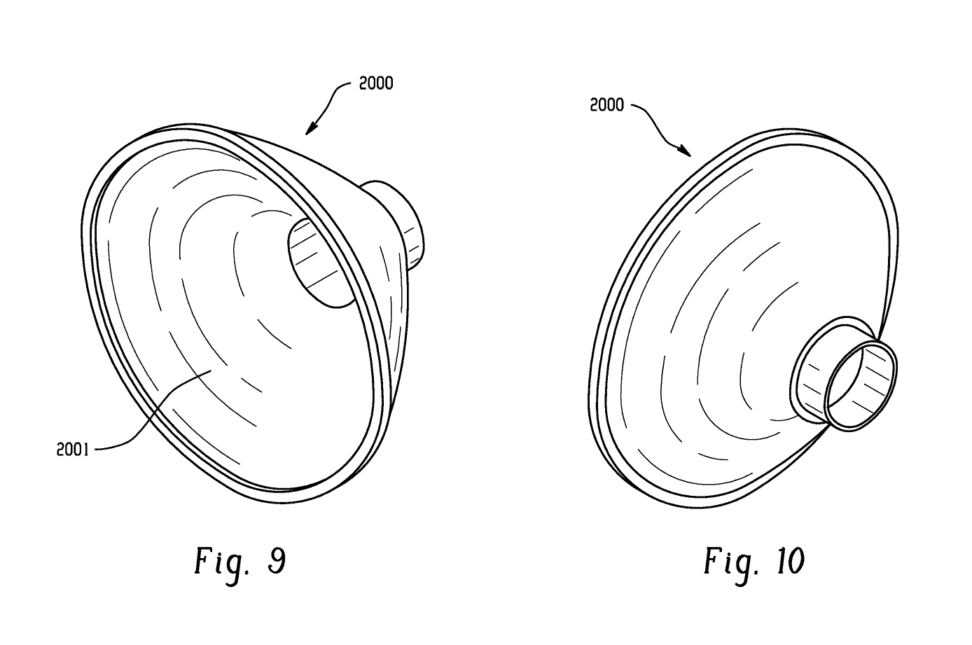

The 3D CAD model of the fluid channels embedded inside the cavity and core for a typical mobile device cover tool is shown in FIG. 8A and FIG. 8B. In both of these assemblies, there exist two distinct loops of heat and cool circuit partitioned about the mid-section considered along their widths. In addition, in the circuit loops for the cavity side, both the inlet and outlet for the fluid are aligned along the same plane, which differs from core, where they are set perpendicular to each other. Set forth below are some embodiments of connectors and methods of making connectors as disclosed herein.

During each cycle of the conformal heat and cool molding process, the operating conditions of the medium flowing inside the heat and cool circuits is maintained constant and the details are tabulated in Table 2.

TABLE 2

| | Heat Cycle | Cool Cycle | Water Flow |
|---|---|---|---|
| Operating | Temperature | Temperature | Rate |
| Conditions | (° C.) | (° C.) | (liters/min) |
| Cavity Cooling Inlet | 125 | 75 | 7 |
| Core Cooling Inlet | 125 | 75 | 7 |

Despite that the boiling point of the water at Standard Temperature and Pressure (STP) is 100° C., its liquid state is still maintained while it enters the circuit at 125° C., during the heat cycle. This is made possible by maintaining the inlet pressure of the water at 2.3 bar which is a higher value compared to the atmospheric pressure of 1 bar at STP. The purpose is to maintain the surface temperature of the mold core and cavity above the glass transition temperature of the polymer of which it is made, so that the aesthetic defects on the molded plastic parts are reduced. Similarly, during the cool cycle, the inlet temperature of the water is maintained at 75° C. This is done to ensure that, the plastic part to be ejected at the end of cool cycle, is maintained below the solidification temperature of the polymer of which it is made, so that the defects due to warpage are reduced. Finally the flow rate of the fluid during both the heat and cool cycle are maintained at 7 liters/min. Before the start of the heat and cool cycle, the initial temperature of the cavity and core are maintained at 25° C.

During the mold heat cycle, the hot water at 125° C. maintained at a pressure 2.3 bar is allowed to flow through the conformal heat and cool circuit at a flow rate of 7 liters/min. This heat cycle is continued until, the surface temperature of the cavity and core side interface of the mold have attained the equilibrium temperature equal or very close to the hot fluid temperature of 125° C. It has been found that, for the present configuration, it takes 12 seconds for the mold to attain the hot equilibrium temperature.

It can be observed that at 12 seconds, the cavity core mold interface surface temperature has reached its equilibrium and its distribution is uniform. The hot equilibrium temperature is attained about 12 seconds after the start of heat cycle.

Once the core and cavity mold surface temperature reaches above the glass transition temperature of the polymer material being processed, the polymer melt is injected into the cavity profile. In this case study the melt is injected from 12 to 13 seconds after the core and cavity mold surface temperature reached is 125° C. During polymer melt injection cycle the hot water circulation is maintained at 125° C. This ensures that the core and cavity mold surfaces temperature is maintained above the glass transition temperature and helps to improve surface aesthetics and reduce the mold defects such as weld lines, flow marks, etc. It can be observed that the polymer melt injected between cavity and core mold surfaces is maintained at 300° C., the water flowing inside heat and cool circuit is maintained at 125° C.

After the completion of polymer melt injection and packing inside the mobile cover mold, the core and cavity mold surfaces are cooled by circulating the water at 75° C. and flow rate of 7 liters/min through the same conformal heat and cool circuits. In the experimental facility, switching from heat to cool mode is achieved through a valve station control system built into the equipment. It has been found that, for the present configuration, it takes 7 seconds for the mold to attain the cold equilibrium temperature. It can be observed that at the 20th second, the cavity and core mold surface temperature has attained its uniform cold equilibrium temperature. Similarly, the cold equilibrium temperature is attained about 7 seconds after the end of polymer melt injection cycle.

Another specific embodiment of the present invention is shown in FIGS. 9-14. FIGS. 9 and 10 show a representation of the front and back sides a generic plastic automotive lighting reflector 2000 that can be molded in a cavity and core type mold having conformal cooling designs incorporated into both the cavity and core portions of the mold. These conformal cooling designs can be incorporated into the mold portions using additive manufacturing techniques as described above. After molding is complete, the inner surface 2001 of the front side of the generic plastic automotive lighting reflector 2000 can be treated to reduce the average surface roughness (i.e., to form smooth surface as described above) before coating a highly reflective optical surface onto the inner surface 2001 using conventional coating techniques.

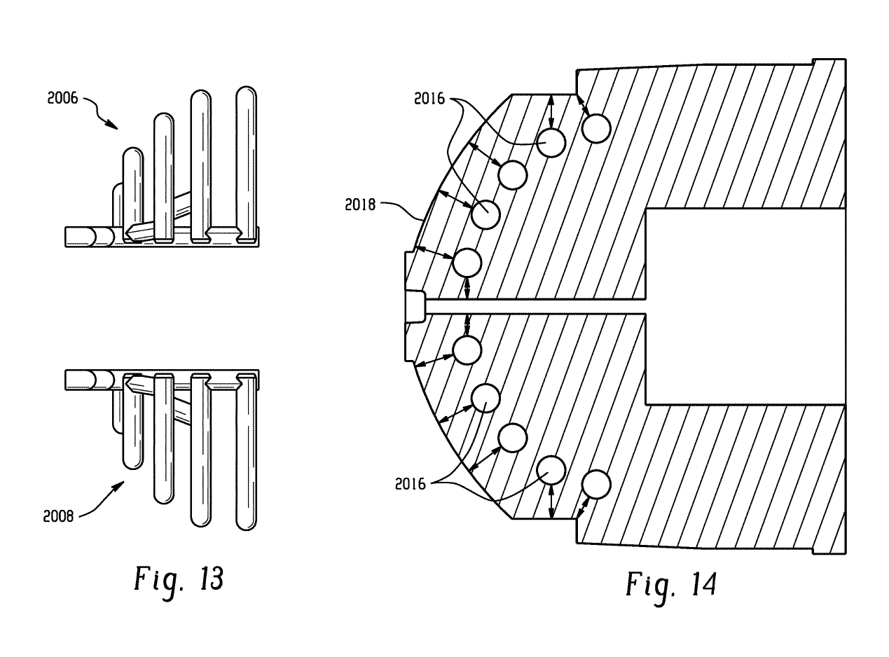

FIG. 11 is a representation of an exploded view of a cavity and core mold having conformal cooling designs incorporated into both cavity and core portions that make makes the generic plastic automotive lighting reflector 2000. In FIG. 11, the cavity portion of the mold is represented as 2002 and the core portion of the mold is represented as 2004. The cavity portion has both an upper conformal cooling design 2006 and a lower conformal cooling design 2008 incorporated therein. These conformal cooling designs 2006 and 2008 are made by additive manufacturing techniques and together form a spiral design. FIG. 13 provides a side view of these upper conformal cooling design 2006 and a lower conformal cooling design 2008. The core portion also has a conformal cooling design 2010 incorporated therein. That conformal cooling design 2010 is also made by additive manufacturing techniques and forms a spiral design. These spiral conformal cooling designs 2006, 2008 and 2010 inside the cavity 2002 and core 2004 provide many advantages. These include maintaining uniform temperature distribution, providing better dimensional stability of the molded part 2000, providing higher productivity by reducing molding cycle time, and providing very quick heating and cooling of the molding surface.

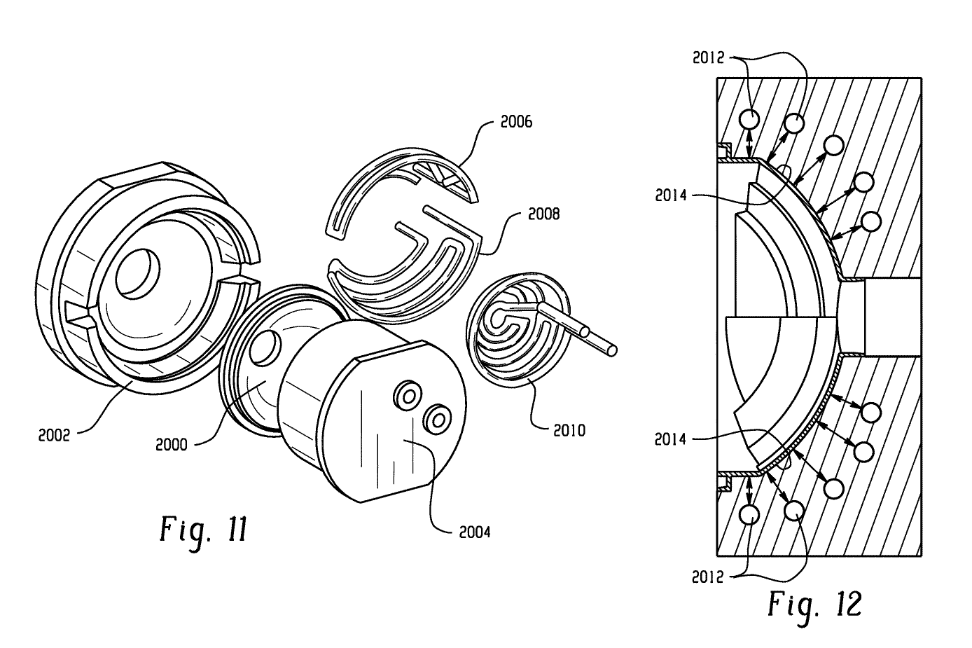

FIG. 12 is a representation of a sectional view of the cavity portion of the mold shown in FIG. 11. In this sectional view, the spiral shaped conformal cooling lines are shown as cooling holes 2012 are shown in approximately equal distance surrounding the molding surface 2014 on the cavity portion as shown by the arrows between them. In one embodiment, the distance between these conformal cooling holes 2012 and the cavity molding surface can range from 4 to 6 mm and the distance been each conformal cooling hole or line can be 4 to 6 mm and the diameter of these conformal cooling holes or line can be from 3 to 5 mm.

FIG. 14 is a representation of a sectional view of the core portion of the mold shown in FIG. 11. In this sectional view, the spiral shaped conformal cooling lines are shown as cooling holes 2016 are shown in approximately equal distance surrounding the molding surface 2018 on the core portion as shown by the arrows between them. In one embodiment, the distance between these conformal cooling holes 2016 and the core molding surface can range from 4 to 6 mm and the distance been each conformal cooling hole or line can be 4 to 6 mm and the diameter of these conformal cooling holes or line can be from 3 to 5 mm.

The present invention can also be described by the further specific embodiments.

### Embodiment 1

A method for forming a mold apparatus comprising: forming a cavity portion through an additive manufacturing process; wherein the cavity portion comprises a cavity molding surface having a surface roughness of greater than or equal to about 0.025 μm and a plurality of cavity fluid channels; wherein the cavity fluid channels comprise a profile conforming to the profile of the cavity molding surface; treating the cavity molding surface to reduce the surface roughness to less than about 0.025 μm; forming a core portion through additive manufacturing; wherein the core portion comprises a core molding surface and a plurality of core fluid channels; wherein the core fluid channels conform to the core molding surface.

### Embodiment 2

The method of Embodiment 1, wherein treating the cavity molding surface comprises machining the molding surface.

### Embodiment 3

The method of Embodiments 1 or 2, further comprising treating the core molding surface to reduce the surface roughness to less than or equal to about 0.025 μm.

### Embodiment 4

The method of Embodiment 3, wherein core molding surface comprises machining the molding surface of the core portion.

### Embodiment 5

The method of any of Embodiments 1-4, wherein at least a portion of the plurality of cavity and core fluid channels are non-linear.

### Embodiment 6

The method of any of Embodiments 1-5, wherein the additive manufacturing process comprises laser sintering, laser fusing, laser metal deposition.

### Embodiment 7

The method of any of Embodiments 1-6, wherein the distance between the core mold surface and the core fluid channels varies by less than 3% across the core mold surface.

### Embodiment 8

The method of any of Embodiments 1-7, wherein the distance between the cavity mold surface and the cavity fluid channels varies by less than 3% across the cavity mold surface.

### Embodiment 9

The method of any of Embodiments 1-8, wherein the core and cavity portions comprise steel, hardened steel, pre hardened steel, hot work steel, stainless hot work steel, and combinations including at least one of the foregoing.

### Embodiment 10

A method of forming a mold apparatus comprising: forming a cavity insert comprising a cavity surface having roughness of less than or equal to about 0.025 μm; forming a cavity portion opposite the cavity surface through additive manufacturing; wherein the cavity portion comprises a plurality of cavity fluid channels; wherein the cavity fluid channels comprise a profile conforming to the profile of the cavity molding surface; forming a core portion through additive manufacturing; wherein the core portion comprises a core molding surface and a plurality of core fluid channels; wherein the core fluid channels conform to the core molding surface.

### Embodiment 11

The method of Embodiment 10, wherein treating the cavity molding surface comprises machining the molding surface.

### Embodiment 12

The method of Embodiments 10 or 11, further comprising treating the core molding surface to reduce the surface roughness to less than or equal to 0.025 μm.

### Embodiment 13

The method of Embodiment 12, wherein core molding surface comprises machining the molding surface of the core portion.

### Embodiment 14

The method of any of Embodiments 10-13, wherein at least a portion of the plurality of cavity and core fluid channels are non-linear.

### Embodiment 15

The method of any of Embodiments 10-14, wherein the additive manufacturing process comprises laser sintering, laser fusing, laser metal deposition.

### Embodiment 16

The method of any of Embodiments 10-15, wherein the distance between the core mold surface and the core fluid channels varies by less than 3% across the core mold surface.

### Embodiment 17

The method of any of Embodiments 10-16, wherein the distance between the cavity mold surface and the cavity fluid channels varies by less than 3% across the cavity mold surface.

### Embodiment 18

The method of any of Embodiments 10-17, wherein the core and cavity portions comprise steel, hardened steel, pre hardened steel, hot work steel, stainless hot work steel, and combinations including at least one of the foregoing.

### Embodiment 19

A mold apparatus made by the method of any of Embodiments 1-18.

### Embodiment 20

A mold apparatus comprising: a core portion comprising a core molding surface and a plurality of core fluid channels; wherein the core fluid channels conform to the profile of the core molding surface; a cavity portion comprising a cavity molding surface and a plurality of cavity fluid channels; wherein the cavity fluid channels conform to the profile of the cavity surface; wherein at least one of the core molding surface and the cavity molding surface comprise a roughness of less than about 0.025 μm.

### Embodiment 21

The mold apparatus of Embodiment 20, wherein the core surface and cavity surface comprise a metallic material.

### Embodiment 22

The mold apparatus of Embodiments 20 or 21, wherein at least a portion of the core fluid channels and the cavity fluid channels is nonlinear.

### Embodiment 23

The mold apparatus of any of Embodiments 20-22, wherein the distance between the core mold surface and the core fluid channels varies by less than 3% across the core mold surface.

### Embodiment 24

The mold apparatus of any of Embodiments 20-23, wherein the distance between the cavity mold surface and the cavity fluid channels varies by less than 3% across the cavity mold surface.

### Embodiment 25

A method for molding a polymer comprising: heating a core molding surface through passing a heated fluid through a plurality of core channels; wherein the plurality of core channels conform to the core molding surface; wherein the core molding surface comprises a roughness of less than or equal to about 0.025 μm; heating a cavity molding surface through passing a heated fluid through a plurality of cavity channels; wherein the plurality of cavity channels conform to the cavity molding surface; wherein the cavity molding surface comprises a roughness of less than or equal to about 0.025 μm; injecting a polymeric material between the core portion and the cavity portion; applying pressure to the polymeric material to form a polymeric product; cooling the core molding surface and the cavity molding surface through passing a cooling fluid through the plurality of core fluid channels and cavity channels; ejecting the polymeric product.

### Embodiment 26

The method of Embodiment 25, wherein heating the core molding surface and cavity molding surfaces comprises passing pressurized liquid water through the channels.

### Embodiment 27

The method of Embodiments 25 or 26, wherein cooling the core molding surface and cavity molding surface comprises passing liquid water through the channels.

### Embodiment 28

The method of any of Embodiments 25-27, wherein the distance between the cavity mold surface and the cavity channels varies by less than 3% across the cavity mold surface.

### Embodiment 29

The method of any of Embodiments 25-28, wherein the distance between the core mold surface and the core fluid channels varies by less than 3% across the core mold surface.

### Embodiment 30

A thermoplastic article made through the method of Embodiments 25-29.

The invention may alternately include, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/we claim:

1. A method for forming a mold apparatus comprising:
forming a cavity portion through an additive manufacturing process;
wherein the cavity portion comprises a cavity molding surface having a surface roughness of greater than or equal to about 0.025 μm and a plurality of cavity channels;
wherein the cavity channels comprise a profile conforming to the profile of the cavity molding surface;
treating the cavity molding surface to reduce the surface roughness to less than about 0.025 μm;
forming a core portion through additive manufacturing;
wherein the core portion comprises a core molding surface and a plurality of core channels;
wherein the core channels conform to the core molding surface.

2. The method of claim 1, wherein treating the cavity molding surface comprises machining the molding surface.

3. The method of claim 1, further comprising treating the core molding surface to reduce the surface roughness to less than or equal to about 0.025 μm and wherein said treating core molding surface comprises machining the molding surface of the core portion.

4. The method of claim 1, wherein at least a portion of the plurality of cavity and core channels are non-linear.

5. The method of claim 1, wherein the additive manufacturing process comprises laser sintering, laser fusing, laser metal deposition.

6. The method of claim 1, wherein the distance between the core mold surface and the core channels varies by less than 3% across the core mold surface and wherein the distance between the cavity mold surface and the cavity channels varies by less than 3% across the cavity mold surface.

7. A method of forming a mold apparatus comprising:
forming a cavity insert comprising a cavity surface having roughness of less than or equal to about 0.025 μm;
forming a cavity portion opposite the cavity surface through additive manufacturing;
wherein the cavity portion comprises a plurality of cavity channels;
wherein the cavity channels comprise a profile conforming to the profile of the cavity molding surface;
forming a core portion through additive manufacturing;
wherein the core portion comprises a core molding surface and a plurality of core channels;
wherein the core channels conform to the core molding surface.

8. The method of claim 7, wherein treating the cavity molding surface comprises machining the molding surface.

9. The method of claim 7, further comprising treating the core molding surface to reduce the surface roughness to less than or equal to 0.025 μm and wherein said treating core molding surface comprises machining the molding surface of the core portion.

10. The method of claim 7, wherein at least a portion of the plurality of cavity and core channels are non-linear.

11. The method of claim 7, wherein the additive manufacturing process comprises laser sintering, laser fusing, laser metal deposition.

12. The method of claim 7, wherein the distance between the core mold surface and the core channels varies by less than 3% across the core mold surface and wherein the distance between the cavity mold surface and the cavity channels varies by less than 3% across the cavity mold surface.

13. The method of claim 1, wherein the core and cavity portions comprise steel, hardened steel, pre hardened steel, hot work steel, stainless hot work steel, and combinations including at least one of the foregoing.

14. A mold apparatus made by the method of claim 1.

15. A mold apparatus comprising:
a core portion comprising a core molding surface and a plurality of core channels;
wherein the core channels conform to the profile of the core molding surface;
a cavity portion comprising a cavity molding surface and a plurality of cavity channels;
wherein the cavity channels conform to the profile of the cavity surface;
wherein at least one of the core molding surface and the cavity molding surface comprise a roughness of less than about 0.025 μm.

16. The mold apparatus of claim 15, wherein the core surface and cavity surface comprise a metallic material; wherein at least a portion of the core channels and the cavity channels is nonlinear; wherein the distance between the core mold surface and the core channels varies by less than 3% across the core mold surface; and wherein the distance between the cavity mold surface and the cavity channels varies by less than 3% across the cavity mold surface.

17. A method for molding a polymer using the molding apparatus of claim 15, the method comprising:
heating a core molding surface through passing a heated fluid through a plurality of core channels;
wherein the plurality of core channels conform to the core molding surface;
wherein the core molding surface comprises a roughness of less than or equal to about 0.025 μm;
heating a cavity molding surface through passing a heated fluid through a plurality of cavity channels;
wherein the plurality of cavity channels conform to the cavity molding surface;
wherein the cavity molding surface comprises a roughness of less than or equal to about 0.025 μm;
injecting a polymeric material between the core portion and the cavity portion;
applying pressure to the polymeric material to form a polymeric product;
cooling the core molding surface and the cavity molding surface through passing a cooling fluid through the plurality of core fluid channels and cavity channels;
ejecting the polymeric product.

18. The method of claim 17, wherein heating the core molding surface and cavity molding surfaces comprises passing pressurized liquid water through the cavity channels and the core channels; wherein cooling the core molding surface and cavity molding surface comprises passing liquid water through the core channels and the cavity channels; wherein the distance between the cavity mold surface and the cavity channels varies by less than 3% across the cavity mold surface; wherein the distance between the core mold surface and the core channels varies by less than 3% across the core mold surface.

19. A thermoplastic article made through the method of claim 17.

20. The thermoplastic article of claim 19, wherein the thermoplastic article is an automotive lighting reflector.
